(19) United States
(12) Patent Application Publication
(10) Pub. No.: US 2018/0172019 A1
(43) Pub. Date: Jun. 21, 2018

(54) ROTARY MACHINE

(71) Applicant: IHI Corporation, Koto-ku (JP)

(72) Inventors: Kuniaki IIZUKA, Koto-ku (JP); Takashi YOSHIDA, Koto-ku (JP); Tatsumi INOMATA, Koto-ku (JP); Takuya OZASA, Koto-ku (JP); Kouta KIMACHI, Koto-ku (JP)

(73) Assignee: IHI Corporation, Koto-ku (JP)

(21) Appl. No.: 15/577,420

(22) PCT Filed: Jun. 8, 2016
(86) PCT No.: PCT/JP2016/067100

§ 371 Date: Nov. 28, 2017

(30) Foreign Application Priority Data
Jun. 11, 2015 (JP) 2015-118059

(51) Int. Cl. F04D 29/28; F04D 29/059; F02B 39/10; F02B 33/40; F04D 25/06

(52) U.S. Cl. CPC F04D 29/284; F04D 29/059; F04D 25/06; F02B 33/40; F02B 39/10

(57) ABSTRACT

A rotary machine includes an impeller which is attached to one end portion in an axial direction of a rotating shaft; and a bearing which is attached to the rotating shaft on a rear surface side of the impeller. The impeller includes a cylindrical boss portion, a hub portion, and a blade portion. A rear surface of the hub portion is provided with a recessed portion recessed toward the one end side from an end edge on the rear surface side of the hub portion in the axial direction. The other end in the axial direction of the boss portion is disposed inside the recessed portion, and an end surface on the one end side of the bearing is disposed inside the recessed portion.

### TECHNICAL FIELD

This disclosure relates to a rotary machine in which a rotating shaft is supported by a bearing and an impeller attached to the rotating shaft can be rotated.

### BACKGROUND ART

As such a technology, as described in Patent Document 1, an electric supercharger in which a compressor wheel (impeller) is attached to a rotating shaft and a motor rotor fixed to the rotating shaft is rotated by a motor is known. In the electric supercharger, a bearing is provided between the compressor wheel and the motor rotor. The bearing supports one side of the motor rotor.

### CITATION LIST

### Patent Literature

Patent Document 1: Japanese Unexamined Patent Publication No. 2012-102700

### SUMMARY OF INVENTION

### Technical Problem

In the above-described structure in the related art, the bearing is provided between the rear surface side of the impeller and the motor rotor. Therefore, the length from the bearing to the tip end of the rotating shaft includes the entire axial length of the impeller. When the length from the bearing to the tip end of the rotating shaft is long, it is also difficult to increase the critical speed of the shaft system. This disclosure describes a rotating shaft capable of increasing the critical speed of a shaft system.

### Solution to Problem

According to an aspect of this disclosure, a rotary machine includes: a rotating shaft rotatably supported in a housing; an impeller which is attached to one end portion in an axial direction of the rotating shaft and is rotatable integrally with the rotating shaft; and a bearing which is attached to the rotating shaft on a rear surface side of the impeller and rotatably supports the rotating shaft to the housing, in which the impeller includes a cylindrical boss portion through which the rotating shaft penetrates, a hub portion which is connected to the boss portion and extends in a radial direction of the rotating shaft, and a blade portion which protrudes from the boss portion and the hub portion in the radial direction and toward one end side in the axial direction, a rear surface of the huh portion is provided with a recessed portion recessed toward the one end side from an end edge on the rear surface side of the hub portion in the axial direction, the other end in the axial direction of the boss portion is disposed inside the recessed portion, and an end surface on the one end side of the bearing is disposed inside the recessed portion.

### Effects of Invention

According to the aspect of this disclosure, the critical speed of a shaft system can be increased.

### BRIEF DESCRIPTION OF DRAWINGS

FIG. 1 is a sectional view of a rotary machine according to a first embodiment of this disclosure.

FIG. 2 is an enlarged sectional view of the part A in FIG. 1.

FIG. 3 is a view illustrating the positional relationship between an impeller and a bearing.

FIG. 4 is a sectional view illustrating a rotating section of a rotary machine according to a second embodiment of this disclosure.

### DESCRIPTION OF EMBODIMENTS

According to an aspect of this disclosure, a rotary machine includes: a rotating shaft rotatably supported in a housing; an impeller which is attached to one end portion in an axial direction of the rotating shaft and is rotatable integrally with the rotating shaft; and a bearing which is attached to the rotating shaft on a rear surface side of the impeller and rotatably supports the rotating shaft to the housing, in which the impeller includes a cylindrical boss portion through which the rotating shaft penetrates, a hub portion which is connected to the boss portion and extends in a radial direction of the rotating shaft, and a blade portion which protrudes from the boss portion and the hub portion in the radial direction and toward one end side in the axial direction, a rear surface of the hub portion is provided with a recessed portion recessed toward the one end side from an end edge on the rear surface side of the hub portion in the axial direction, the other end in the axial direction of the boss portion is disposed inside the recessed portion, and an end surface on the one end side of the bearing is disposed inside the recessed portion.

In the rotary machine, the impeller is provided with the recessed portion at the rear surface of the hub portion. Since the end surface of the bearing is disposed inside the recessed portion, the length from the bearing to the tip end of the rotating shaft can be reduced. Accordingly, the critical speed of the shaft system can be increased.

In some aspects, the housing is provided with a bearing surrounding portion which surrounds the bearing from an outer circumferential side and the one end side and protrudes into the recessed portion, and a facing surface of the bearing surrounding portion which faces the hub portion is curved along a surface of the recessed portion. In this case, not only the bearing but also the bearing surrounding portion, which is a part of the housing, also protrude into the recessed portion of the impeller and are disposed inside the recessed portion. Therefore, it becomes easier for the impeller to be brought close to the bearing. As a result, the amount of overhang of the shaft tip end portion and the center of gravity of the impeller from the bearing is reduced, and the above-described actions and effects are more favorably exhibited.

In some aspects, the housing is provided with a bearing surrounding portion which surrounds the bearing from an outer circumferential side and the one end side and protrudes into the recessed portion, and a part of the bearing surrounding portion faces the one end side of the bearing.

In some aspect, the bearing is a radial ball bearing including an inner race press-fitted to the rotating shaft and an outer race that is rotatable relative to the inner race via a plurality of balls, and the inner race abuts the boss portion of the impeller. In this case, the impeller is brought as close as possible to the bearing. Therefore, it becomes easier for the tip end of the rotating shaft to be brought close to the bearing, and the above-described actions and effects are more favorably exhibited.

In some aspect, the rotating shaft is provided with a rotor portion, the housing is provided with a stator portion, and the rotary machine is an electric supercharger which rotates the rotating shaft and the impeller by an interaction between the rotor portion and the stator portion.

Hereinafter, an embodiment of this disclosure will be described with reference to the drawings. In the description of the drawings, like elements are denoted by like reference numerals, and redundant descriptions will be omitted.

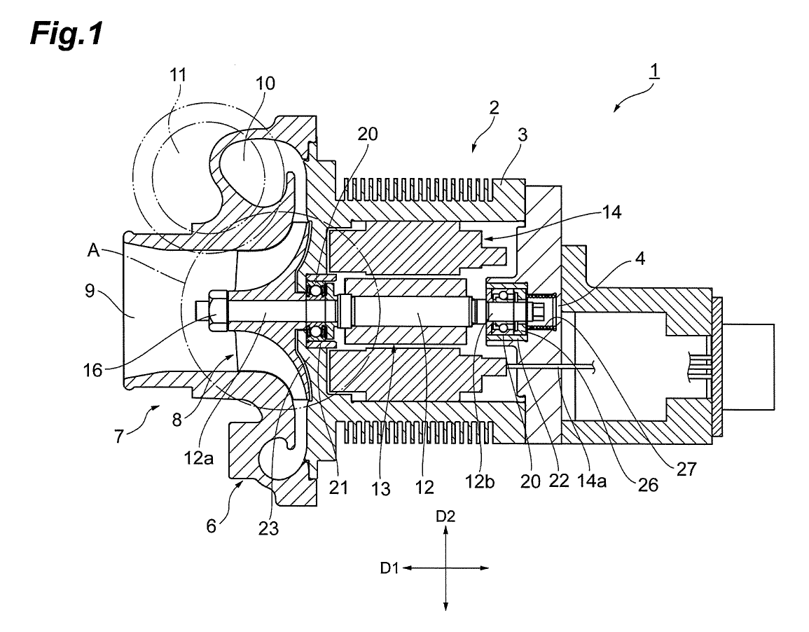

An electric supercharger (rotary machine) 1 according to a first embodiment will be described with reference to FIG. 1. As illustrated in FIG. 1, the electric supercharger 1 is applied to, for example, an internal combustion engine of a vehicle or a ship. The electric supercharger 1 includes a compressor 7. In the electric supercharger 1, a compressor impeller 8 is rotated by the interaction between a rotor portion 13 and a stator portion 14 to compress a fluid such as air and generate compressed air.

The electric supercharger 1 includes a rotating shaft 12 rotatably supported in a housing 2 and the compressor impeller 8 fixed to a tip end portion (one end portion) 12a of the rotating shaft 12. The housing 2 includes a motor housing 3 in which the rotor portion 13 and the stator portion 14 are stored, and an end wall 4 that closes an opening on the other end side (the right side in the figure) of the motor housing 3. A compressor housing 6 in which the compressor impeller 8 is stored is provided on one end side (the left side in the figure) of the motor housing 3. The compressor housing 6 includes an intake port 9, a scroll portion 10, and a discharge port 11.

The compressor impeller 8 is made of, for example, a resin or carbon fiber reinforced resin (hereinafter, referred to as “CFRP”, CFRP: Carbon Fiber Reinforced Plastic), and thus a reduction in weight is achieved.

The rotor portion 13 is fixed to the center portion in an axial direction D1 of the rotating shaft 12 and includes one or a plurality of permanent magnets (not illustrated) attached to the rotating shaft 12. The stator portion 14 is fixed to the inner surface of the motor housing 3 so as to surround the rotor portion 13, and includes a coil portion (not illustrated) having a lead wire 14a wound thereon. When an alternating current is supplied to the coil portion of the stator portion 14 through the lead wire 14a, the rotating shaft 12 and the compressor impeller 8 rotate integrally due to the interaction between the rotor portion 13 and the stator portion 14. When the compressor impeller 8 rotates, the compressor impeller 8 draws outside air through the intake port 9, compresses the air through the scroll portion 10, and discharges the air from the discharge port 11. The compressed air discharged from the discharge port 11 is supplied to the internal combustion engine mentioned above.

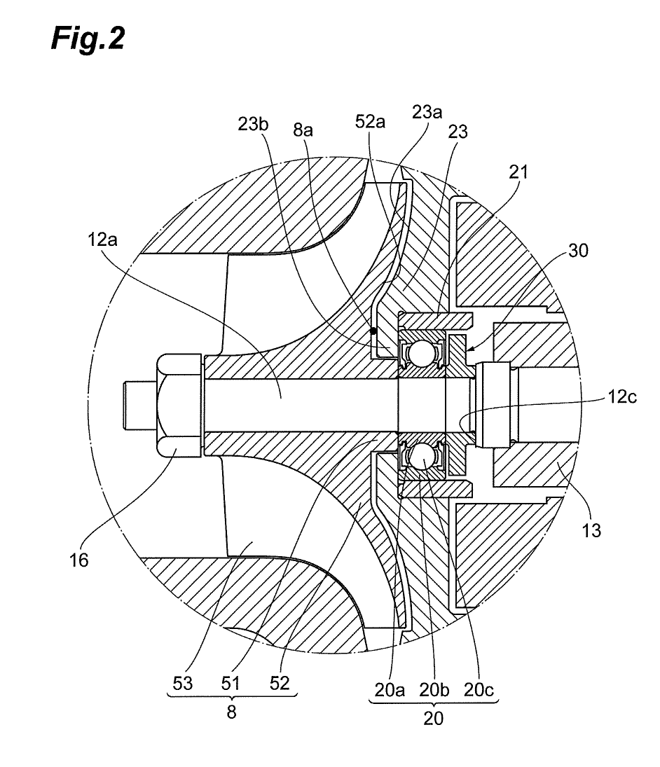

The electric supercharger 1 includes two ball bearings (bearings) 20 that are press-fitted to the rotating shaft 12 and rotatably support the rotating shaft 12 to the housing 2. The ball bearings 20 are respectively provided near the tip end portion 12a and a base end portion 12b of the rotating shaft 12, and support the rotating shaft 12 at both sides. The ball bearing 20 is, for example, a grease lubrication type radial ball bearing. More specifically, the ball bearing 20 may be a deep groove ball bearing or an angular contact ball bearing. As illustrated in FIG. 2, the ball bearing 20 includes an inner race 20a press-fitted to the rotating shaft 12 and an outer race 20b that is rotatable relative to the inner race 20a via a plurality of balls 20c.

One ball bearing 20 is attached to the rear surface side (the right side in the figure) of the compressor impeller 8. A cylindrical bearing sleeve (cylindrical portion) 21 is attached to the outer circumferential side of one ball bearing 20. As illustrated in FIG. 1, the ball bearing 20 and the bearing sleeve 21 are fixed to the rotating shaft 12 by a shaft end nut 16 provided at the tip end portion 12a of the rotating shaft 12. The cylindrical bearing sleeve 21 is disposed on the outer circumferential side of one ball bearing 20. The bearing sleeve 21 is press-fitted into a bearing surrounding portion 23 formed on one end side in the axial direction D1 of the motor housing 3.

The other ball bearing 20 is attached between the rotating shaft 12 and the end wall 4. A cylindrical bearing sleeve (cylindrical portion) 22 is attached to the outer circumferential side of the other ball bearing 20. The bearing sleeve 22 is press-fitted to a cylindrical portion formed to protrude inward from the center of the end wall 4 in the motor housing 3. An annular spring receiver 26 is provided between the other ball bearing 20 and the end wall 4. The spring receiver 26 is biased toward one side in the axial direction D1 by a spring 27 disposed in the cylindrical portion at the center of the end wall 4.

The motor housing 3 is made of, for example, aluminum. On the other hand, the inner race 20a and the outer race 20b of the ball bearing 20 are made of iron. Therefore, the bearing sleeves 21 and 22 which are made of iron such as carbon steel and have the same degree of hardness as the ball bearings 20 are provided between the ball bearings 20 and the motor housing 3. The bearing sleeves 21 and 22 surround the ball bearings 20 from the outer circumferential side. Accordingly, the motor housing 3 made of a relatively soft material is protected from attrition.

The rotating shaft 12, and the compressor impeller 8, the rotor portion 13, the ball bearings 20, and the spring receiver 26 fixed to the rotating shaft 12 integrally constitute a rotating section in the housing 2 and are biased toward one side in the axial direction D1. An annular portion 23b which is a part of the hearing surrounding portion 23 faces one end side of the ball bearing 20 such that the rotating section is positioned in the axial direction D1.

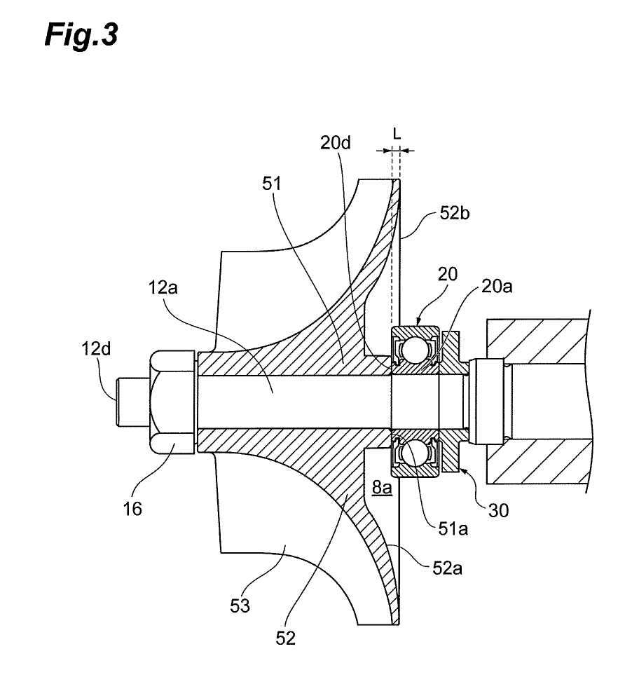

Subsequently, the bearing structure of the electric supercharger 1 will be described in detail with reference to FIGS. 2 and 3. As illustrated in FIGS. 2 and 3, the compressor impeller 8 includes a cylindrical boss portion 51 through which the rotating shaft 12 penetrates, a hub portion 52 which is connected to the boss portion 51 and extends in a radial direction D2 of the rotating shaft 12, and a blade portion 53 which protrudes from the boss portion 51 and the hub portion 52 in the radial direction D2 and toward one end side (the left side in the figure) in the axial direction D1.

The boss portion 51 abuts the inner race 20a of the ball bearing 20. The hub portion 52 has a curved surface. The blade portion 53 has a three-dimensional shape according to the performance required of the compressor impeller 8.

The rear surface of the hub portion 52 is provided with a recessed portion 8a recessed toward one end side (the left side in the figure) in the axial direction D1. The recessed portion 8a is recessed toward one end side in the axial direction D1 from an end edge 52b on the rear surface side of the hub portion 52 in the axial direction D1. By forming the rear surface of the compressor impeller 8 into a cut-out shape as well as by causing the compressor impeller 8 to be made of CFRP, a reduction in the weight of the compressor impeller 8 is achieved.

Furthermore, the other end 51a in the axial direction D1 of the boss portion 51 is disposed in the recessed portion 8a. One end surface 20d in the axial direction D1 of the ball bearing 20 is disposed in the recessed portion 8a. As illustrated in FIG. 3, an advancing length L by which one end surface 20d of the ball bearing 20 advances into the recessed portion 8a may be equal to or less than half of the length (thickness) in the axial direction D1 of the ball bearing 20, or may be equal to or less than ¼ thereof. The advancing length L may be equal to or more than half of the length (thickness) in the axial direction D1 of the ball bearing 20. In a case where a thin ball bearing 20 is employed, the entire ball bearing 20 may be disposed in the recessed portion 8a.

One end surface 20d of the inner race 20a of the ball bearing 20 abuts the other end 51a of the boss portion 51 in the recessed portion 8a.

As illustrated in FIG. 2, the motor housing 3 is provided with the above-mentioned bearing surrounding portion 23 surrounding the ball bearing 20 from the outer circumferential side and one end side. The bearing surrounding portion 23 having a truncated cone shape protrudes into the recessed portion 8a. In other words, the entirety or a part of the annular portion 23b of the bearing surrounding portion 23 is disposed inside the recessed portion 8a. A facing surface 23a of the bearing surrounding portion 23 which faces the hub portion 52 is curved along the surface 52a of the recessed portion 8a. Accordingly, a gap that extends to be thinly curved is provided between the surface 52a of the recessed portion 8a and the facing surface 23a of the bearing surrounding portion 23.

In the electric supercharger 1 of this embodiment described above, the compressor impeller 8 is provided with the recessed portion 8a at the rear surface of the huh portion 52. Since one end surface 20d of the ball bearing 20 is disposed inside the recessed portion 8a, the length from the ball bearing 20 to the tip end 12d (see FIG. 3) of the rotating shaft 12 is reduced. Accordingly, the deflection amount of the tip end 12d of the rotating shaft 12 of the electric supercharger 1 is reduced, and the critical speed of the shaft system increases. As the critical speed increases, the rotational speed of the rotating shaft 12 can be increased. In addition, since the length from the ball bearing 20 to the tip end 12d of the rotating shaft 12 is reduced, the compressor impeller 8 can be reduced in weight, which in turn contributes to an improvement in transient performance.

In the electric supercharger 1, not only the ball bearing 20 but also the bearing surrounding portion 23, which is a part of the housing 2, also protrude into the recessed portion 8a of the compressor impeller 8 and are disposed inside the recessed portion 8a. At least a part of the annular portion 23b is disposed inside the recessed portion 8a. Therefore, it becomes easier for the tip end 12d of the rotating shaft 12 to be brought close to the ball bearing 20, and the above-described actions and effects are more favorably exhibited.

Furthermore, the boss portion 51 of the compressor impeller 8 is brought as close as possible to the ball bearing 20 by being allowed to abut the ball bearing 20. Therefore, it becomes easier for the tip end 12d of the rotating shaft 12 to be brought close to the ball bearing 20, and the above-described actions and effects are more favorably exhibited.

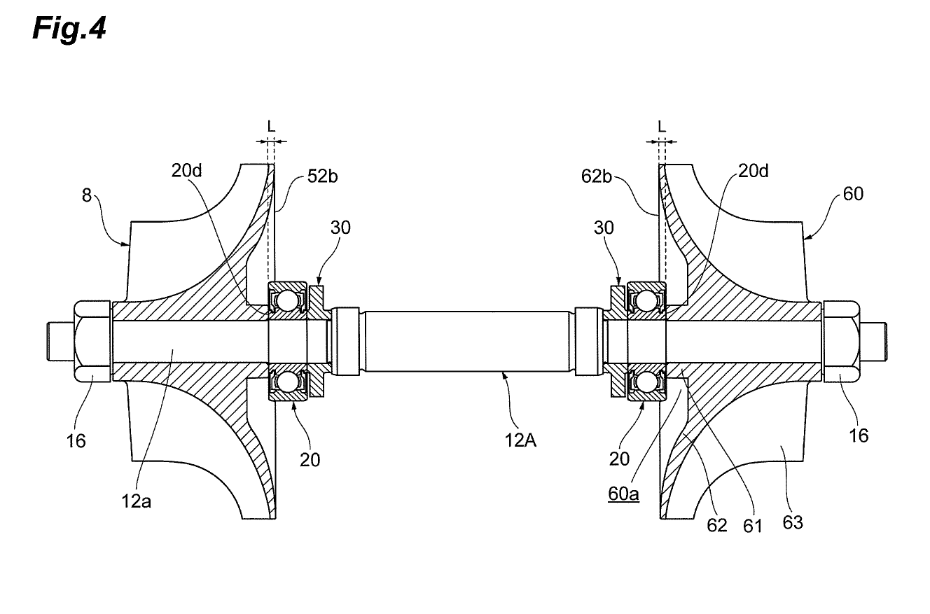

While the embodiment of this disclosure has been described above, the present invention is not limited to the embodiment. For example, instead of the electric supercharger 1, the present invention can be applied to a known supercharger that rotates a rotating shaft and an impeller by the driving force of a turbine. Furthermore, for example, as illustrated in FIG. 4, two compressor impellers may be provided coaxially. In the example illustrated in FIG. 4, the compressor impeller 8 is fixed to one end portion 12a of a rotating shaft 12A, and a second compressor impeller 60 is fixed to the other end portion 12b of the rotating shaft 12A. The second compressor impeller 60 includes a boss portion 61, a hub portion 62, and a blade portion 63, and a recessed portion 60a is provided on the rear surface side of the hub portion 62. The end surface 20d of the ball bearing 20 is disposed inside the recessed portion 60a and advances from an end edge 62b by an advancing length L. Even with such a structure, the critical speed of the shaft system can be increased.

Furthermore, the bearing surrounding portion 23 may not protrude into the recessed portion 8a. The facing surface 23a of the bearing surrounding portion 23 may not be curved along the surface 52a of the recessed portion 8a but may be significantly distant from the surface 52a of the recessed portion 8a, or may have a different shape from the surface 52a of the recessed portion 8a.

Another member may be interposed between the ball bearing 20 and the boss portions 51 and 61 of the compressor impeller 8 and the second compressor impeller 60.

The bearing is not limited to the grease lubrication type ball bearing. For example, a ball bearing employing another lubrication type (oil lubrication or the like) may also be used. The bearing is not limited to the ball bearing and may also be a sliding bearing.

The material of the impeller is not limited to CFRP. An impeller made of aluminum or an aluminum-containing material, or an impeller made of magnesium or a magnesium-containing material may also be employed. The shape and size (degree of cutting) of the recessed portion of the impeller can be appropriately changed.

The structure of the present invention can be applied to any rotary machine in which a bearing is press-fitted to a rotating shaft. For example, the present invention can be applied to a type of electric supercharger in which rotation is assisted by a motor provided with a turbine. Furthermore, the present invention is not limited to a rotary machine provided with a compressor, and can also be applied to a generator that generates electric power using a turbine.

### INDUSTRIAL APPLICABILITY

According to some aspects of this disclosure, the critical speed of a shaft system can be increased.

### REFERENCE SIGNS LIST

1 electric supercharger (rotary machine)
2 housing
7 compressor
8 compressor impeller (impeller)
8a recessed portion
12 rotating shaft
12A rotating shaft
20 ball bearing (bearing)
20a inner race
20b outer race
20c ball
20d one end surface (end surface)
23 bearing surrounding portion
23a facing surface
23b annular portion (part)
51 boss portion
52 hub portion
52a surface
52b end edge
53 blade portion
60 second compressor impeller (impeller)
60a recessed portion
61 boss portion
62 hub portion
62b end edge
63 blade portion
D1 axial direction
D2 radial direction

1. A rotary machine comprising:
a rotating shaft rotatably supported in a housing;
an impeller which is attached to one end portion in an axial direction of the rotating shaft and is rotatable integrally with the rotating shaft; and
a bearing which is attached to the rotating shaft on a rear surface side of the impeller and rotatably supports the rotating shaft to the housing,
wherein the impeller includes a cylindrical boss portion through which the rotating shaft penetrates, a hub portion which is connected to the boss portion and extends in a radial direction of the rotating shaft, and a blade portion which protrudes from the boss portion and the hub portion in the radial direction and toward one end side in the axial direction,
a rear surface of the hub portion is provided with a recessed portion recessed toward the one end side from an end edge on the rear surface side of the hub portion in the axial direction,
the other end in the axial direction of the boss portion is disposed inside the recessed portion,
an end surface on the one end side of the bearing is disposed inside the recessed portion,
the bearing is a radial ball bearing including an inner race press-fitted to the rotating shaft and an outer race that is rotatable relative to the inner race via a plurality of balls, and
the inner race abuts the boss portion of the impeller.

2. The rotary machine according to claim 1,
wherein the housing is provided with a bearing surrounding portion which surrounds the bearing from an outer circumferential side and the one end side and protrudes into the recessed portion, and
a facing surface of the bearing surrounding portion which faces the hub portion is curved along a surface of the recessed portion.

3. The rotary machine according to claim 1,
wherein the housing is provided with a bearing surrounding portion which surrounds the bearing from an outer circumferential side and the one end side and protrudes into the recessed portion, and
a part of the bearing surrounding portion faces the one end side of the bearing.

4. (canceled)

5. The rotary machine according to claim 1,
wherein the rotating shaft is provided with a rotor portion,
the housing is provided with a stator portion, and
the rotary machine is an electric supercharger which rotates the rotating shaft and the impeller by an interaction between the rotor portion and the stator portion.

6. The rotary machine according to claim 2,
wherein the rotating shaft is provided with a rotor portion,
the housing is provided with a stator portion, and
the rotary machine is an electric supercharger which rotates the rotating shaft and the impeller by an interaction between the rotor portion and the stator portion.

7. The rotary machine according to claim 3,
wherein the rotating shaft is provided with a rotor portion,
the housing is provided with a stator portion, and
the rotary machine is an electric supercharger which rotates the rotating shaft and the impeller by an interaction between the rotor portion and the stator portion.
